(19) United States
(12) Patent Application Publication
(10) Pub. No.: US 2012/0293674 A1
(43) Pub. Date: Nov. 22, 2012

(54) IMAGE STABILIZATION SYSTEM AND DIGITAL CAMERA

(75) Inventor: Yukio UENAKA, Tokyo (JP)

(73) Assignee: PENTAX RICOH IMAGING COMPANY, LTD., Tokyo (JP)

(21) Appl. No.: 13/469,348

(22) Filed: May 11, 2012

(30) Foreign Application Priority Data
May 18, 2011 (JP) 2011-111805

(51) Int. Cl. H04N 5/228

(52) U.S. Cl. 348/208.99; 348/E05.031

(57) ABSTRACT

An image stabilization system is provided that includes a rolling angle detector for detecting a rolling angle of a camera body; a rotational blur compensator that calculates a rotational blur from the rolling angle and carries out a rotational compensation by rotating an image sensor; a translational motion detector for detecting a translational motion of the camera body; and a translational blur compensator that extracts a partial image from each of two images captured by the image sensor to counteract the translational motion.

### BACKGROUND OF THE INVENTION

1. Field of the Invention

The present invention relates to a digital camera provided with image stabilization functionality, and more specifically to a digital camera that is capable of compensating for not only translational blur in horizontal and vertical directions but also blur caused by rotation about the optical axis.

2. Description of the Related Art

Image blur due to camera shake includes translational components (translational blur) caused by yawing and pitching of a camera, and a rotational component (rotational blur) caused by its rolling. An electronic or digital image stabilization system is known that compensates for the blurring, including the rotational blur, by motion vectors calculated between one frame and the subsequent frame. Namely, the amount of rotation and translation between the two images is obtained from the motion vectors so that an area corresponding to the same object or a common image area can be extracted (refer to U.S. patent application publication No. 2007-297694A). Further, as for an optical image stabilization system that is capable of compensating for the rotational blur, there is known a system that detects yaw, pitch and roll angles of the camera by angular velocity sensors, and rotates and translates an image sensor in a plane parallel to the imaging surface of the image sensor to counteract the blurring (refer to U.S. Pat. No. 7,796,873).

### SUMMARY OF THE INVENTION

However, when compensating the rotational blur as well as the translational blur using the digital image stabilization system, the amount of calculation increases and thus extending the processing time. Further, when a roll angle is increased, the size of the common image area that can be extracted from the two images is reduced and an allowable range for the extracted area to be shifted is reduced. On the other hand, as for the optical image stabilization system, complicated calculations are not used. However, the rotational blur compensation performed in the optical image stabilization has a disadvantage in downsizing because an area required for an optical element that is moved to counteract the blurring must be enlarged to incorporate a rotational movement.

Therefore, one aspect of the present invention is to provide an image stabilization system that can promptly counteract camera shake including a rolling motion, as well as save space.

According to the present invention, an image stabilization system is provided. The image stabilization system includes a rolling angle detector, a rotational blur compensator, a translational motion detector and a translational blur compensator.

The rolling angle detector detects a rolling angle of a camera body. The rotational blur compensator calculates a rotational blur from the rolling angle and carries out a rotational compensation by rotating an image sensor. The translational motion detector detects a translational motion of the camera body. The translational blur compensator extracts a partial image from each of two images captured by the image sensor to counteract the translational motion.

Further, according to the present invention, a digital camera is provided that includes the camera body, the image sensor, the rolling angle detector, the rotational blur compensator, the translational motion detector and the translational blur compensator.

### BRIEF DESCRIPTION OF THE DRAWINGS

The objects and advantages of the present invention will be better understood from the following description with reference to the accompanying drawings in which:

FIG. 1 is a rear perspective view of a digital camera of a present embodiment showing an arrangement of sensors and a shake-reduction unit;

FIG. 2 is a plan view illustrating an arrangement of components provided on a movable portion of the shake-reduction unit of the present embodiment;

FIG. 3 is a block diagram showing an electrical construction of the digital camera of the present embodiment;

FIG. 4 is a block diagram schematically illustrating the flow of the rotational blur compensation process and translational blur compensation value calculation;

FIG. 5 shows geometrical relationships between the reference position P_{X0} of the Hall effect sensor 22X and the position P_{X1} where the Hall effect sensor 22X will be moved in response to the rolling angle θ_{L};

FIG. 6, shows geometrical relationships between the reference positions P_{YL0} and P_{YR0} of the Hall effect sensors 22YL and 22YR and the positions P_{YL1} and P_{YR1} where the Hall effect sensors 22YL and 22YR will be moved in response to the rolling angle θ_{L};

FIG. 7 is a flowchart of the rotational blur compensation control process and the translational blur compensation value calculation process;

FIG. 8 is a flowchart of the image stabilization process;

FIG. 9 illustrates the relationship between the effective pixel area and an extraction area when the first image is captured;

FIG. 10; illustrates the relationship between the effective pixel area and the extracting area when the second image is captured with a digital image stabilization method from a prior art; and

FIG. 11 illustrates the relationship between the effective pixel area and the extraction area when the second image is captured with the inventive image stabilization method.

### DESCRIPTION OF THE PREFERRED EMBODIMENTS

The present invention is described below with references to the embodiments shown in the drawings.

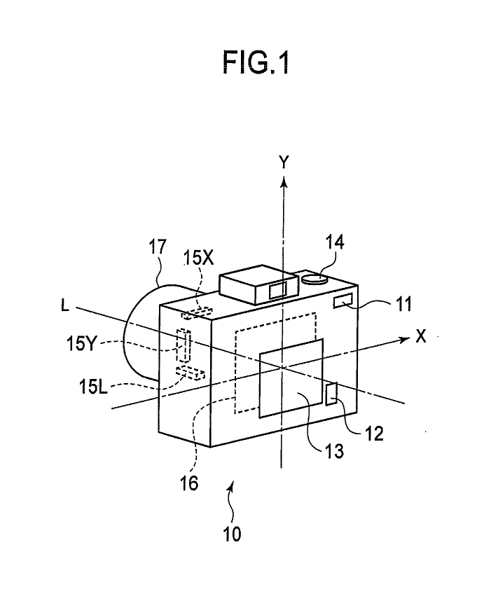

FIG. 1 schematically illustrates a rear perspective view of a digital camera to which an embodiment of the present invention is applied.

On the backside of the digital camera 10, a main power switch 11, a shake-reduction switch 12 for activating an image stabilizing function and a monitor 13 for displaying an image may be provided. Further, a release button 14 may be provided on the top of the camera body. In FIG. 1, three sensors 15L, 15X and 15Y for detecting camera shake and an image stabilizing system or a shake-reduction unit 16, which are housed inside the camera body, are illustrated by broken lines.

The sensors 15L, 15X and 15Y may be angular velocity sensors with each of the sensors detecting angular velocity about three independent axes fixed relative to the camera body, respectively. Displacement or image blur of a stationary subject that is caused by camera shake is calculated from the detected angular velocities so that the shake-reduction unit 16 is driven in accordance with the above-calculated displacement.

One of the aforementioned three axes may be an optical axis L of a lens barrel 17 and the remaining two axes may be orthogonal to the optical axis L. Normally, these two axes correspond to the horizontal axis X and the vertical axis Y of the camera body. In the present embodiment, an angular velocity about the optical axis L, which is a rolling angular velocity, is detected by the angular velocity sensor 15L. Further, angular velocities about the horizontal axis X and the vertical axis Y of the camera body, i.e., a pitching angular velocity and a yawing angular velocity, are detected by the angular velocity sensors 15X and 15Y, respectively.

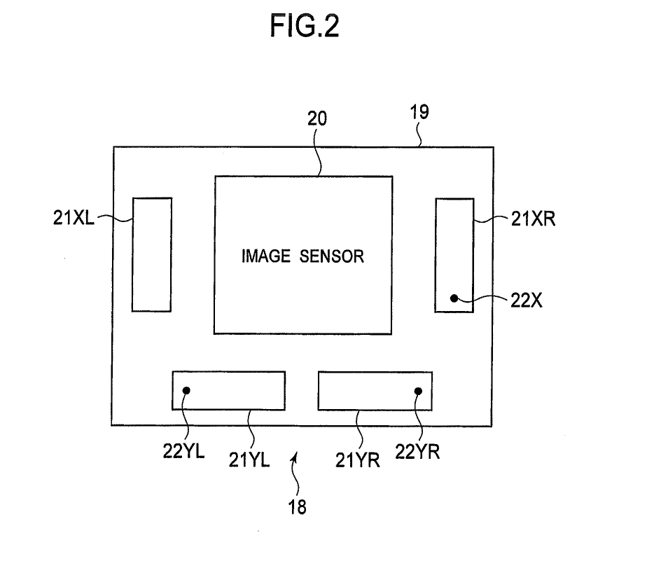

With reference to FIG. 2, the configuration of the shake-reduction unit 16 of the present embodiment will be explained. FIG. 2 illustrates an arrangement of components configuring a movable portion 18 of the shake-reduction unit 16. FIG. 2 is illustrated from the perspective of viewing the movable portion 18 from the backside of the camera body. The movable portion 18 may be a substrate onto which an image sensor 20, four coils 21XR, 21XL, 21YR and 21YL, and three position sensors 22X, 22YR and 22YL are provided. The image sensor 20 may be positioned at about the center of the substrate 19. On the right side of the image sensor 20 the coil 21XR is disposed, and on the left side of the image sensor 20 the coil 21XL is disposed. Further, on the lower side of the image sensor 20 the coil 21YR and the coil 21YL are arranged to align in the horizontal direction with the coil 21YR on the right-hand side and the coil 21YL on the left-hand side.

Hall effect sensors 22X, 22YR and 22YL, which are disposed at locations where the coils 21XR, 21YR and 21YL overlap, are the position sensors for detecting the displacement of the movable portion 18 with respect to a fixed portion. Note that, as will be described later, the movable portion 18 is actuated by an electromagnetic force interacting between the coils 21X, 21YR and 22YL and yokes provided on the fixed portion of the camera body. The coils 21XR and 21XL generate force in the horizontal direction X and the coils 21YR and 21YL generate force in the vertical direction Y.

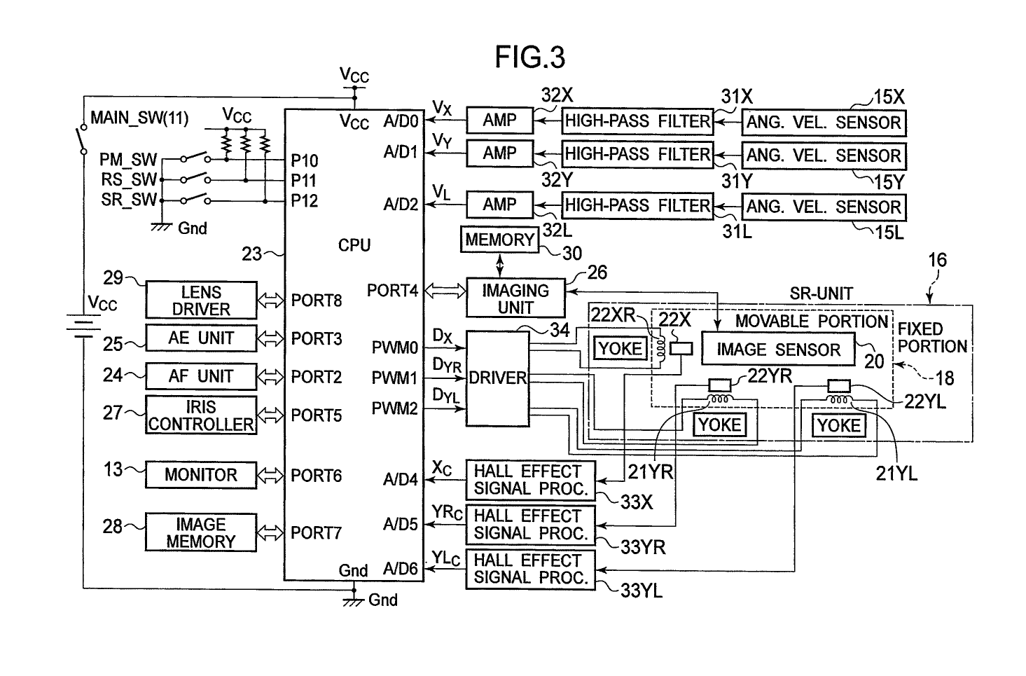

FIG. 3 is a block diagram illustrating the electrical schematic of the digital camera 10 of the present embodiment. The digital camera 10 is mainly controlled by a CPU 23. When the main switch (MAIN SW) is turned on, electric power is supplied to the CPU 23 and each component of the digital camera 10.

The release button 14 is provided with a photometric switch (PM_SW) and a release switch (RSSW). When the release button 14 is half depressed, the photometric switch

(PM_SW) is turned on and photometry is activated. Further, when the release button 14 is fully depressed, the release switch (RS_SW) is turned on and image capturing is activated. The photometric switch (PM_SW), release switch (RS_SW) and shake-reduction switch (SR_SW) are connected to terminals P10-P12 in port 1 of the CPU 23, respectively.

Further, an AF unit 24, AE unit 25, imaging unit 26, iris controller 27, monitor 13, image memory 28 and lens driver 29 are connected to ports 2-8 of the CPU 23. When the photometric switch (PM_SW) is turned on, the CPU 23 starts an autofocus operation and controls the lens driver 29 in accordance with signals from the AF unit 24, and then starts an auto exposure control process in which the iris controller 27 and the imaging unit 26 control the f-number and shutter speed in accordance with signals from the AE unit 25.

In this situation, the imaging unit 26 drives the image sensor 20 to capture images, for example at a rate of 1/60 sec, and temporarily stores the captured images in memory 30 accordingly. Further, the imaging unit 26 reads out the images stored in the memory 30 in order, and outputs the image data to the CPU 23 according to instructions from the CPU 23. The CPU 23 accordingly outputs the input images to the monitor 13 to display the through-the-lens image. Further, when the release switch (RS SW) is turned on, the last image stored in the memory 30 is stored in a nonvolatile image memory 28.

The CPU 23 also has A/D ports A/D0-A/D6. The angular velocity sensors 15X, 15Y and 15L are connected to the A/D ports A/D0-A/D6 via high-pass filters 31X, 31Y and 31L and amplifiers 32X, 32Y and 32L, respectively. Additionally, the Hall effect sensors 22X, 22YR and 22YL provided on the movable portion 18 of the shake-reduction unit 16 are connected to the A/D ports A/D4-A/D6 via Hall effect signal processors 33X, 33YR and 33YL, respectively.

The CPU 23 further includes PWM ports PWM0-PWM2, and the PWM ports PWM0-PWM2 are connected to the coils 21XR, 21XL, 21YR and 21YL of the movable portion 18 via a driver 34. On the fixed portion of the shake-reduction unit 16, individual yokes corresponding to each of the coils are provided so that the movable portion 18 can be translated and/or rotated with respect to the fixed portion by controlling an electric current supplied to each of the coils 21XR, 21XL, 21YR and 21YL. Note that coil 21XL is not depicted in FIG. 3 for lack of space.

While the shake-reduction switch 12 is in the on state, the CPU 23 calculates, for example, a translational component of the camera shake (which causes a translational blur due to rotational movement about the X-axis and Y-axis) and a rotational component of the camera shake (which causes a rotational blur due to rotational movement about the optical axis L) for a predetermined period (e.g. 1 mS), and the driver 34 is controlled on the basis of the rotational blur. Namely, the movable portion 18, on which the image sensor 20 is mounted, is rotated approximately about the center of the image circle to counteract the rotational blur. Further, the position of the movable portion 18, namely the position of the image sensor 20, is detected by the Hall effect sensors 22X, 22YR and 22YL that are provided on the movable portion 18. The positional information detected by the Hall effect sensors 22X, 22YR and 22YL is used for feedback control during the rotational blur compensation process by the shake-reduction unit 16.

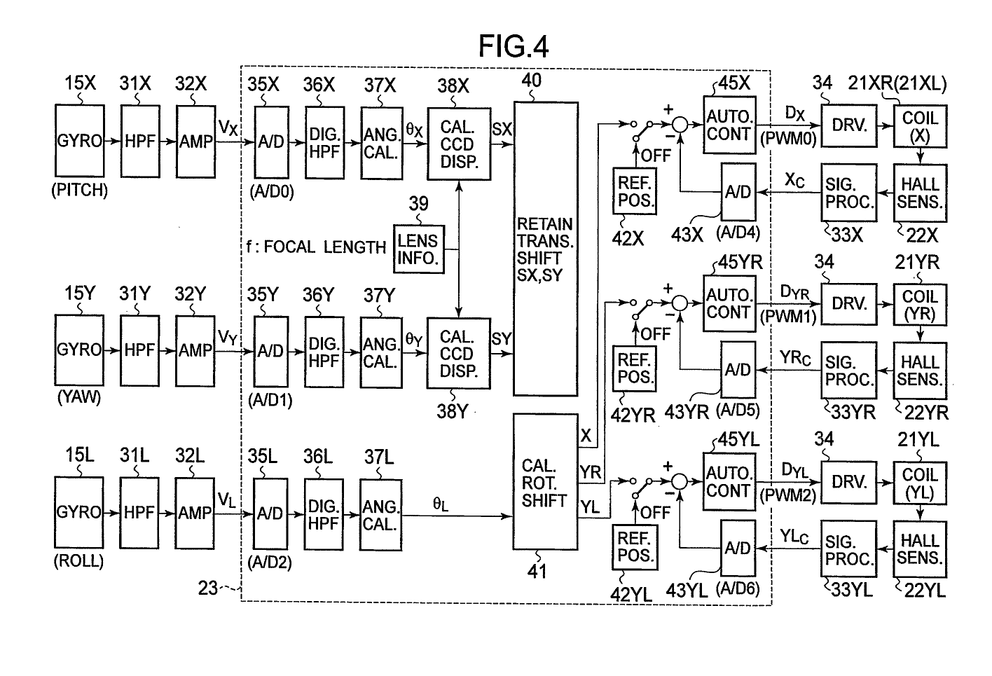

With reference to FIG. 4, the rotational blur compensation control process and translational blur compensation value calculation process that are carried out by the CPU 23 will be explained. Note that FIG. 4 is a block diagram schematically illustrating the entire control flow of the rotational blur compensation control process and translational blur compensation value calculation process, and the blocks within the area surrounded by the broken line are carried out by the CPU 23. These processes may be carried out as interrupt processing at a predetermined interval (e.g. 1 mS).

Signal components due to panning are filtered from signals obtained by each of the gyros in the angular velocity sensors 15X, 15Y and 15L through the analog high-pass filter 31X, 31Y and 12L. The signals are then amplified by amplifiers 32X, 32Y and 32L and are input to the A/D ports A/D0-A/D2 of the CPU 23 as angular velocity signals V_{X}, V_{Y} and V_{L}. The angular velocity signals V_{X}, V_{Y} and V_{L} are subjected to A/D conversion (blocks 35X, 35Y and 35L), and are further subjected to a digital high-pass filter process (blocks 36X, 36Y and 36L) to extract only information related to unexpected hand movement. Further, an integration operation is applied to each of the angular velocity signals V_{X}, V_{Y} and V_{L} and rotational angles in order to obtain the pitching angle θ_{X}, yawing angle θ_{Y} and rolling angle θ_{L} (blocks 37X, 37Y and 36L).

The translational blur compensation value, which corresponds to the shift values SX in the X-direction and SY in the Y-direction, govern how an image of a motionless subject is moved on the imaging surface based on the translational components of the camera shake, and is calculated (block 38X and 38Y) from the yawing angle θ_{Y}, the pitching angle θ_{X} and lens information, such as the focal length f and so on (block 39). The calculated translational shift values SX and SY are stored in memory and updated, accordingly (block 40).

On the other hand, shift values of the movable portion 18 that use the coils 21XR, 21XL, 21YR and 21YL to compensate for rotational blur are calculated from the rolling angle θ_{L} about the optical axis (block 41). In the present embodiment, the shift values of the movable portion 18 for the rotational blur compensation are obtained as a shift value X in the X-direction that is shifted by the coils 21XR and 21XL, a shift value YR in the Y-direction that is shifted by the coil 21YR, and a shift value YL in the Y-direction that is shifted by the coil 21YL.

Here, the shift value X corresponds to the shift from the reference position for the Hall effect sensor 22X in the X-direction. The shift values YR and YL correspond to the shifts from the reference positions for the Hall effect sensors 22YR and 22YL in the Y-direction. The reference positions of each of the Hall effect sensors 22X, 22YR and 22YL may be defined as the positions of the Hall effect sensors 22X, 22YR and 22YL when the movable portion 18 is in the standard position where each side of the image sensor 20 is parallel to either of the X or Y-directions and the center of the effective pixel area is coaxial with the center of the image circle. Note that in the present embodiment, the coils 21XR and 21XL are aligned in the X-direction and both of the coils 21XR and 21XL only contribute to the translation of the movable portion 18 in the X-direction so that the shift values of the movable portion 18 due to the coils 21XR and 21XL can be referred to as the same value X.

Desired values in the shake-reduction unit 16 control may be set to the above-mentioned shift values X, YR and YL, which are calculated per lmS while the shake-reduction function is enabled or the shake-reduction switch 12 is on. On the other hand, when the shake-reduction function is disabled, such that when the shake-reduction switch 12 is off, the image sensor 20 is positioned as the center of its effective pixel area coincides with the center of the image circle and without a tilt. Namely, X=YR=YL=0 are set as the desired value, which corresponds to the position where each of the Hall effect sensors 22X, 22YR and 22YL are at their respective reference positions (blocks 43X, 43YR and 43YL).

Signals detected by the Hall effect sensor 22X, 22YR and 22YL are transformed into signals that represent the displacement X_{C}, YR_{S} and YL_{C} from each of the above-mentioned reference positions. The signals are then input to the CPU 23 via the A/D ports A/D4-A/D6 and digitalized (blocks 43X, 43YR and 43YL).

Each of the displacements X_{C}, YR_{S} and YL_{C} is fed back so that errors from the shift values X, XR and YL, which are set as the desired values or the set points, are obtained. For each of the errors, an auto control operation, such as a PID operation is performed (blocks 45X, 45YR and 45YL) so that each of the signals obtained by the auto control operation is subjected to pulse width modulation and then output to the driver 34 through PWM ports PWM0-PWM2 as manipulating variables D_{X}, D_{YR} and D_{YL}. The driver 34 supplies electric current to the coils 21XR, 21XL, 21YR and 21YL to actuate the movable portion 18 at a driving power that corresponds to the manipulating variables D_{X}, D_{YR} and D_{YL} Thereby, the movable portion 18 is rotated to counteract the rotational blur when the shake-reduction function is enabled, but maintained in the standard position when the shake-reduction function is disabled.

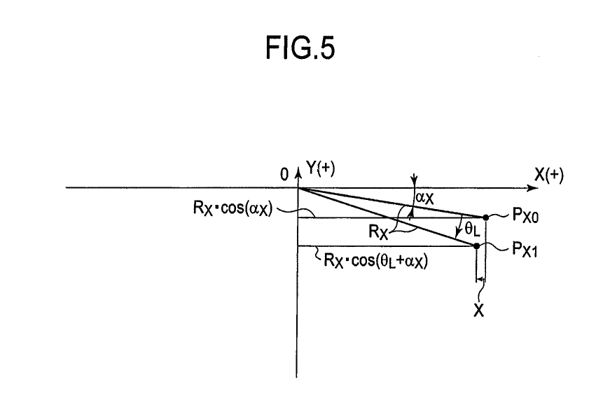

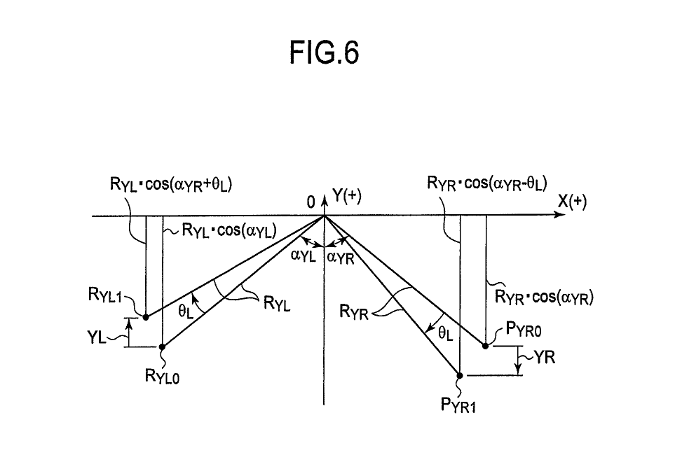

With reference to FIG. 5 and FIG. 6, the calculation of shift values (desired values) X, YR and YL in block 41 of FIG. 4 is explained next.

FIG. 5 illustrates the reference position P_{X0}of the Hall effect sensor 22X on the XY-plane and the position P_{X1} where the Hall effect sensor 22X will be moved in response to the rolling angle θ_{L} in the rotational blur compensation. Similarly, FIG. 6 shows the reference positions P_{YL0} and P_{YR0} of the Hall effect sensors 22YL and 22YR and the positions P_{YL1} and P_{YR1} where the Hall effect sensors 22YL and 22YR will be moved in response to the rolling angle θ_{L} in the rotational blur compensation. Note that FIG. 5 and FIG. 6 are plan views from the side of the monitor 13, see FIG. 1.

As illustrated in FIG. 5, when the reference position P_{X0} of the Hall effect sensor 22X is defined by a radial distance R_{X} and an angle α_{X} from the X-axis with the center of the image circle “O” as the origin (an angle measured in the clockwise direction from the positive X-axis) , the position P_{X1} where the Hall effect sensor 22X will be moved to compensate for the rotational blur caused by the rolling angle θ_{L} has a geometric relationship with the reference position P_{X0} as shown in FIG. 5. Namely, the shift value X is derived as

X=R_{X}*cos(α_{X}+θ_{L})−R_{X}*cos(α_{X}).

On the other hand, as illustrated in FIG. 6, when the reference position P_{YR0} of the Hall effect sensor 22YR is defined by a radial distance R_{YR} and an angle α_{YR} from the Y-axis with the center of the image circle “O” as the origin (an angle measured in the counterclockwise direction from the negative Y-axis) , the position P_{YR1} where the Hall effect sensor 22YR will be moved to compensate for the rotational blur caused by the rolling angle θ_{L} has a geometric relationship with the reference position P_{YR0} as shown in FIG. 6. Namely, the shift value YR is derived as

YR=R_{YR}*cos(α_{YR})−R_{YR}*cos(α_{YR}−θ_{L}).

Similarly, when the reference position P_{YL0} of the Hall effect sensor 22YL is defined by a radial distance R_{YL} and an angle α_{YL} from the Y-axis with the center of the image circle “O” as the origin (an angle measured in the clockwise direction from the negative Y-axis) , the position P_{YL1} where the Hall effect sensor 22YL will be moved to compensate for the rotational blur caused by the rolling angle θ_{L} has a geometric relationship with the reference position P_{YL0} as shown in FIG. 6. Namely, the shift value YL is derived as

YL=R_{YL}*cos(α_{YL})−R_{YL}*cos(α_{YL}+θ_{L}).

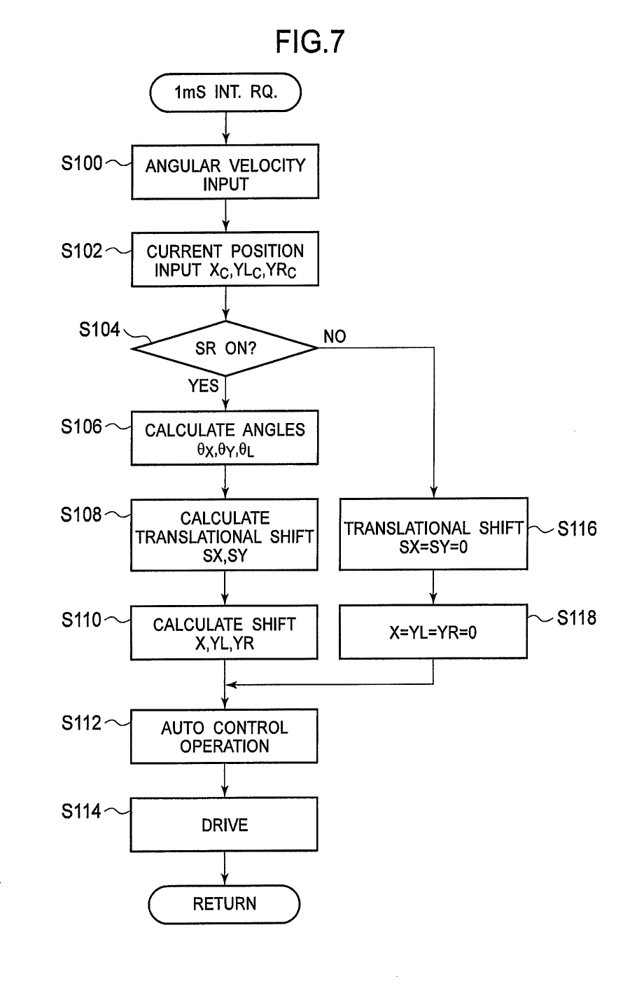

With reference to the flowchart of FIG. 7, the detail of the rotational blur compensation control process and the translational blur compensation value calculation process (interrupt processing), which are generally explained with reference to FIG. 4, will be explained.

When an interrupt request given at a predetermined time interval (e.g., 1 ms) is issued, the process shown in FIG. 7 starts at the CPU 23. At Step S100, the angular velocities (V_{X}, V_{YR}, V_{YL}) of the pitching, yawing and rolling motions are input via the A/D ports A/D0-A/D2 . In Step S102, the current displacements X_{C}, Y_{RC} and Y_{LC} of the current positions P_{X}, P_{LR} and P_{YL} of the Hall effect sensors 22X, 22YR and 22YL from the reference positions P_{X0} P_{YR0} and P_{YL0} in the X and Y directions are input via the A/D ports A/D4-A/D6.

In Step S104, the determination of a shake-reduction flag SR that indicates whether the shake-reduction function is enabled (the shake-reduction switch 12 is on) or not is carried out. When the shake-reduction flag SR is 1 (true), the pitching angle θ_{X}, yawing angle θ_{Y} and rolling angle θ_{L} are calculated in Step S106; then in Step S108 the shift values SX and SY, which correspond to the translational blur, are calculated from the pitching and yawing angles θ_{X} and θ_{Y}, and the lens information including the focal length f.

In Step S110, the magnitude of the shift value X from the reference position P_{X0} that the Hall effect sensor 22X is moved in the X direction, the magnitude of the shift value YR from the reference position P_{YR0} that the Hall effect sensor 22YR is moved in the Y direction, and the magnitude of the shift value YL from the reference position P_{YL0} that the Hall effect sensor 22YL is moved in the Y direction are calculated from the rolling angle θ_{L} and are defined as the desired values (set points) for the rotational blur compensation.

In Step S112, the automatic control operations are conducted with respect to the errors between the desired values X, YR and YL and the current displacements X_{C}, YR_{C} and YL_{C} obtained in Step S102. Thereby, in Step S114, the shake-reduction system 16 is driven in accordance with the manipulating variables DX, DYR and DYL obtained by the automatic control operations and thus this interrupt processing ends.

On the other hand, when the shake-reduction flag SR is 0(false) and thus the shake-reduction system is determined to be disabled (the shake-reduction switch 12 is off), the shift values SX and SY for compensating the translational blur are set to 0 in Step S116. Further, in Step S118, the desired values are also set as X=YR=YL=0 and Steps S112 and S114 are carried out. And then, the interrupt processing ends.

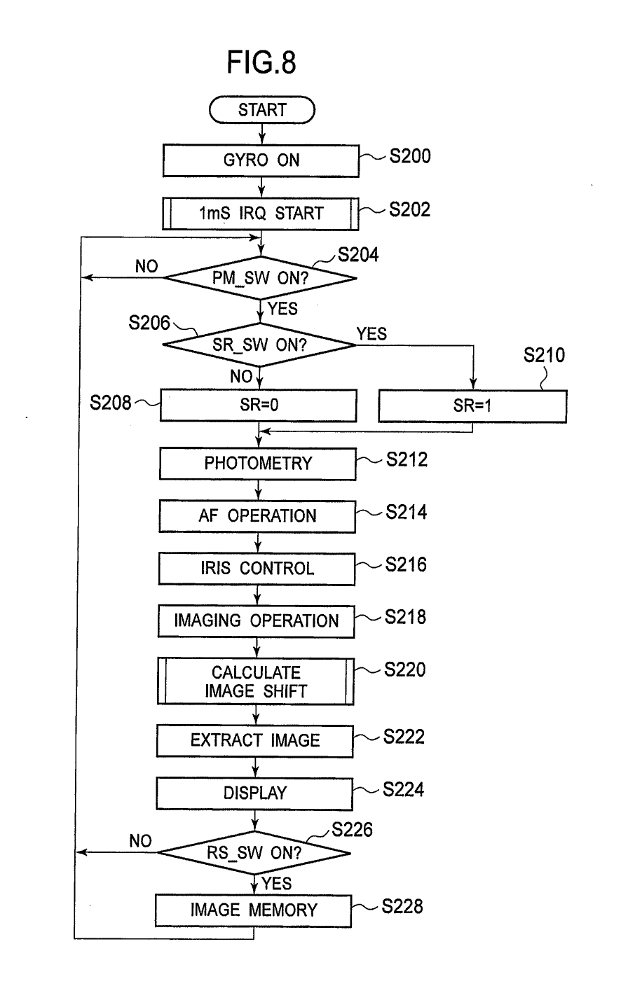

With reference to the flowchart of FIG. 8 and FIG. 3, the general process of the image stabilization operation (the rotational blur compensation and the translational blur compensation) of the present embodiment, which is performed by the CPU 23, will be explained next.

When the main switch 11 is turned on, the gyros of the angular velocity sensors 15X, 15Y and 15L (see FIGS. 1 and 3) are activated in Step S200. In Step S202, the interrupt request per lmS, which carries out the rotational blur compensation and the translational blur compensation as explained with reference to FIG. 7, is initiated.

In Step S204, whether the photometric switch (see FIG. 3) is turned on or not is determined repeatedly. When it is determined that the photometric switch is turned on, the on/off state of the shake-reduction switch (see FIG. 1 or 3) is determined in Step S206. The shake-reduction flag SR is set to 0 (false) in Step S208 when the shake-reduction switch is off; the shake-reduction flag SR is set to 1 (true) in Step 210 when the shake-reduction switch is on. This shake-reduction flag SR, as referred to in Step 104, is explained with reference to FIG. 7.

When the shake-reduction flag SR is set in Step S208 or in Step S210, the photometric operation, AF operation and iris control operation are carried out in Steps S212-S216. In Step S218, the image capturing operation for the image sensor 20 is carried out and an image that is captured by the image sensor 20 is temporarily stored in the memory 30.

In Step S220, the magnitude of the shift values for the pixels used for extracting an image signal from the image captured in Step S218 are calculated from the shift values SX and SY for the translational blur, which are calculated in the interrupt processing of FIG. 7. In Step S222, only the image data corresponding to the extraction area, which is shifted by the shift values calculated in Step S220, is readout from the image stored in the memory 30 and input to the CPU 23 (digital image stabilization).

In Step S224, the extracted image obtained in Step S222 is fed to the monitor 13 and displayed as a through-the-lens image. Further, in Step S226, whether the release switch (see FIG. 3) is turned on or not is determined. When it is determined that the release switch has not been turned on, the process returns to Step S204 and the same procedure is repeated. Note that image capturing for the through-the-lens image by the image sensor 20 and display on the monitor 13 may be repeated at 1/60 seconds interval. Simultaneously, the images displayed on the monitor 13 may also be stored in the image memory 28 as a motion picture.

On the other hand, when it is determined in Step S226 that the release switch has been turned on, the entire image data of the latest image is readout in Step S228 and stored in the image memory 28 (see FIG. 3). Further, the process returns to Step S204 and the same procedure is carried out until the main switch 11 is turned off.

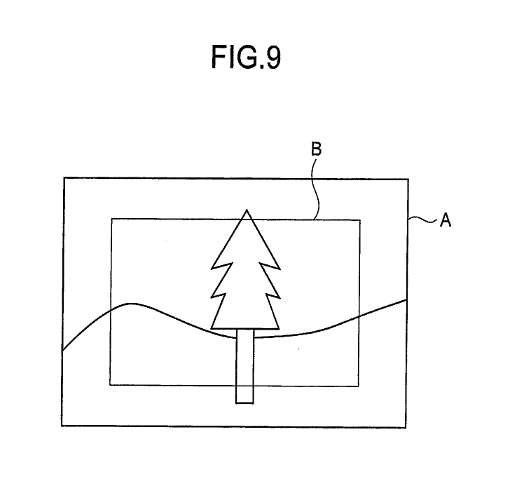

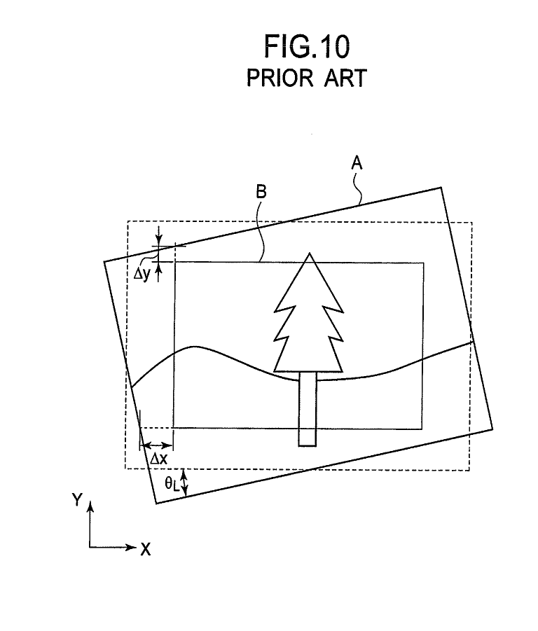

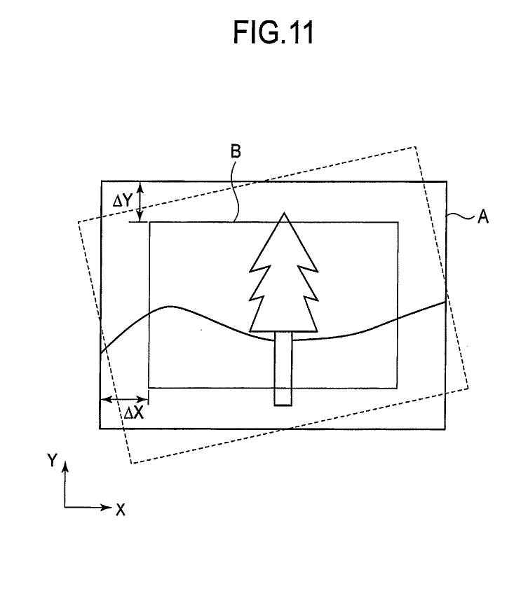

With reference to FIGS. 9-11, the function and effects of the image stabilization operation of the present embodiment will be explained. In FIGS. 9-11, the effective pixel area of the image sensor 20 is designated as a rectangular area A and an extraction area from which a through-the-lens image is extracted is designated as a rectangular area B. FIG. 9 illustrates a situation when the first image is captured. Both of FIGS. 10 and 11 illustrate when the second image is captured with the camera body being rotated from the position in FIG. 9 by rolling angle θ_{L}. FIG. 10 illustrates a case when the digital image stabilization method of a prior art is used. On the other hand, FIG. 11 illustrates a case when the image stabilization method of the present embodiment is used.

As for the digital image stabilization method of the prior art that is illustrated in FIG. 10, the image sensor 20 is rotated together with the camera body. Therefore, when the second image is captured, the effective pixel area A is inclined at the rolling angle θ_{L} from the position indicated by a broken line that corresponds to the effective pixel area A of FIG. 9. However, in order to extract the same subject image, the extraction area B of FIG. 10 is equal to the extraction area B of FIG. 9. Namely, the extraction area B of a rectangular area is inclined from the effective pixel area A by the rolling angle θ_{L}. Therefore, translation of the extraction area B is limited to Δx in the X direction and to Δy in Y direction.

On the other hand, as illustrated in FIG. 11, according to the image stabilization method of the present embodiment, the position of the image sensor 20 is maintained at the original position without rotating, even though the camera body has been rotated about the optical axis L. Thereby, the positions of the effective pixel area A and the extraction area B do not change from their previous positions indicated in FIG. 9, in which the first image is captured, so that the extraction area B is not inclined from the effective pixel area A. Therefore, the extracting area B in the present embodiment can be shifted ΔX (>Δx) in the X-direction and ΔY (>Δy) in the Y-direction to compensate for a translational blur. Namely, the image stabilization of the present embodiment is able to compensate for a larger translational blur or can define a larger extraction area than those in the digital image stabilization methods of prior art.

As described above, according to the present embodiment, image stabilization or shake reduction including a rotational blur compensation is promptly and efficiently carried out even when a motion picture, such as through-the-lens image, is captured and represented on a monitor or stored in memory concurrently, by mechanically compensating for a rotational blur (rotating the image sensor by detecting a rolling angle) while digitally compensating for a translational blur (extracting an area corresponding to the subject image). Further, the shake-reduction system can be downsized.

Namely, since it is not required to generate motion vectors from two succeeding images or fields and analyze the motion vectors in the present embodiment, the image extraction can be accelerated. Further, in the present embodiment, the mechanical-type compensation is only applied to the rotational blur and the digital-type compensation is employed to compensate for the translational blur so that it is not necessary for the image sensor to be moved in the horizontal and vertical directions in order to compensate for a translational blur. Thereby, the movable area for the movable portion can be reduced.

Note that in the present embodiment, the sensors for detecting the amount of a translational blur are provided and the extraction area is shifted in the horizontal (X) and vertical (Y) directions according to the detected amount of the translational blur. However, the shift values in the horizontal and vertical directions can also be calculated from the motion vectors obtained from two succeeding images instead of providing the sensors for detecting the translational blur. In this case, the motion vectors may be generated from two images in the same field per 1/30 second and analyzed. Namely, the interrupt request of FIG. 7 may be requested at ⅓ mS intervals instead of 1 mS. Even in this situation, the operation time is reduced compared to the prior digital image stabilization since the displacement due to the rotation (rolling) motion is not calculated from the motion vectors.

Although the embodiment of the present invention has been described herein with reference to the accompanying drawings, obviously many modifications and changes may be made by those skilled in this art without departing from the scope of the invention.

The present disclosure relates to subject matter contained in Japanese Patent Application No. 2011-111805 (filed on May 18, 2011), which is expressly incorporated herein, by reference, in its entirety.

1. An image stabilization system, comprising:
a rolling angle detector for detecting a rolling angle of a camera body;
a rotational blur compensator that calculates a rotational blur from the rolling angle and carries out a rotational compensation by rotating an image sensor;
a translational motion detector for detecting a translational motion of the camera body; and
a translational blur compensator that extracts a partial image from each of two images captured by the image sensor to counteract the translational motion.

2. The image stabilization system as in claim 1, wherein the translational motion detector comprises a yawing angle detector for detecting a yawing angle of the camera body and a pitching angle detector for detecting a pitching angle of the camera body, with the translational motion calculated from the yawing angle and the pitching angle.

3. The image stabilization system as in claim 1, wherein the translational motion detector detects the translational motion from motion vectors generated between the two images.

4. The image stabilization system as in claim 1, wherein the partial images extracted by the translational blur compensator are output in order as a through-the-lens image.

5. A digital camera, comprising:
a camera body;
an image sensor;
a rolling angle detector for detecting a rolling angle of the camera body;
a rotational blur compensator that calculates a rotational blur from the rolling angle and carries out a rotational compensation by rotating the image sensor;
a translational motion detector for detecting a translational motion of the camera body; and
a translational blur compensator that extracts a partial image from each of two images captured by the image sensor to counteract the translational motion.
